(19) United States
(12) Patent Application Publication
(10) Pub. No.: US 2005/0051490 A1
(43) Pub. Date: Mar. 10, 2005

(54) [APPATAUS AND METHOD FOR SIMULATNEOUSLY PROCESSING WASTE OZONE AND DRAINED WATER]

(76) Inventors: Shin-Tong Wu, Nantou County (TW); Chin-Hsiang Peng, Hsinchu City (TW); Jer-Min Chang, Taichung County (TW); Ming-Jen Huang, Miaoli County (TW); Jody Liang, Hsinchu County (TW); Chi-Chieh Tsao, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,792

(22) Filed: Oct. 28, 2003

(30) Foreign Application Priority Data
Sep. 5, 2003 (TW) 92124556

(51) Int. Cl. C02F 1/42; C02F 1/78

(52) U.S. Cl. 210/668; 210/681; 210/760; 210/192; 210/266

(57) ABSTRACT

A process apparatus for processing wasted ozone and drained water simultaneously is disclosed. The apparatus includes a process device, a ozone generator, a drain water tank, a gas/liquid mixing device, a decomposition device and a adsorption device. The ozone generator is coupled to the process device for supplying ozone to the process device. The drain tank at least includes a drain water inlet and a drain water outlet. The gas/liquid mixing device includes a gas inlet, a liquid inlet and a liquid outlet. The liquid inlet is coupled to the drain water outlet of drain water tank; the gas inlet is coupled to the ozone generator. The gas/liquid mixing device is used for dissolving ozone into drain water. The decomposition device is coupled to the gas/liquid mixing device for decomposing the organic carbon in the drain water. The adsorption device is coupled to the decomposition device for adsorbing ions in the drain water.

### BACKGROUND OF INVENTION

1. Field of the Invention

The present invention relates to an apparatus and a method of semiconductor manufacturing, and more particularly to an apparatus and a method for simultaneously processing waste ozone and drained water.

2. Description of the Related Art

Ozone easily dissolves and restores to oxygen under normal temperature and pressure due to its instability, which means that it is a powerful oxidant. Because of its characteristic, ozone has been publicly used in semiconductor manufacturing, such as chemical vapor deposition, plasma etch, wafer cleaning, etc. As to the process equipments in which ozone is applied, an ozone generator is coupled to these equipments for generating ozone continuously. When ozone is required, ozone will be introduced to the process equipments. If not, ozone is introduced to other device as waste. Because ozone is a powerful oxidant, leakage of ozone is harmful for operators, damages process equipments and pollutes environment. Therefore, waste ozone should be processed.

FIG. 1 is a schematic drawing showing a prior art apparatus for processing ozone. Please referring to FIG. 1, a process device 100 is coupled to an ozone generator 102. A valve 104a is deposed between the process device 100 and the ozone generator 102. The ozone generator 102 is coupled to a local scrubber 106. A valve 104b is deposed between the ozone generator 102 and the local scrubber 106. When ozone should be applied to the process device 100, the valve 104a is opened and the valve 104b is closed for introducing ozone into the process device 100. When ozone should not be applied to the process device 100, the valve 104a is closed and the valve 104b is opened for introducing waste ozone into the local scrubber 106. Then, ozone is processed by a combustion process within the local scrubber 106. Water is introduced through a cleaning liquid inlet 108 for an absorption process, gas is vented through an outlet 110 and water is drained through an outlet 112.

However, in the process for processing waste ozone described above, the efficiency of processing ozone is not so good that ozone does not substantially dissolve and removed through the drain pipeline, instead that ozone exists as a gas in the drain pipeline. Therefore, ozone can corrode the drain pipeline. Moreover, the waste ozone generated by the ozone generator is a manufacturing cost.

In another aspect, total organic value (TOC) of drained water from semiconductor manufacturing processes is about 2 to 3 ppm, which should be processed by reverse osmosis (RO) or exposed to UV light for recycling. The additional process also increases the manufacturing cost.

### SUMMARY OF INVENTION

The object of the present invention is to provide an apparatus and a method for simultaneously processing waste ozone and drained water which uses waste ozone generated form process device for reducing total organic carbon of drained water and simultaneously reduces the waste ozone and organic carbon of the drained water; therefore, the manufacturing cost is reduced.

Another object of the present invention is to provide an apparatus and a method for simultaneously processing waste ozone and drained water which can efficiently remove waste ozone and reduce total organic carbon of the drained water; therefore, service life of drained water pipelines can be increased.

The present invention disclosed an apparatus for simultaneously processing waste ozone and drained water. The apparatus includes a process device, an ozone generator, a drained water tank, a gas/liquid mixing device, a decomposition device and an absorption device. The ozone generator is coupled to the process device for proving ozone thereto. The drained water tank at least includes a drained water inlet and a drained water outlet. The gas/liquid mixing device includes a gas inlet, a gas outlet and an outlet. The liquid inlet is coupled to the drained water outlet of the drained water tank and the gas inlet is coupled to the ozone generator for substantially dissolving ozone into drained water. The decomposition device is coupled to the gas/liquid mixing device for decomposing organic carbon in the drained water. The absorption device is coupled to the decomposition device for absorbing ions within the drained water.

In the apparatus for simultaneously processing waste ozone and drained water described above, the gas/liquid mixing device is a dissolving pump, the decomposition device is a UV lamp and the absorption device includes active carbon or ion-exchange resin. The drained water outlet of the drained water tank is coupled to a local scrubber.

The present invention further disclosed a method for simultaneously processing waste ozone and drained water. The method includes first collecting waste ozone and drained water of a process device. The waste ozone is then substantially dissolved into the drained water. Then, a generating ratio of the hydroxyl ions of the drained water is increased for reducing total organic carbon of the drained water. Ions within the drained water then are absorbed.

In the method described above, the step of substantially dissolving the waste ozone into the drained water includes using a dissolving pump for substantially dissolving the waste ozone into the drained water. The step of increasing the generating ratio of hydroxyl ions of the drained water for reducing total organic carbon of the drained water includes exposing the drained water by using a UV lamp to dissolve the organic carbon of the drained water. The step of absorbing ions from the drained water includes absorbing the ions from the drained water by using active carbon or ion-exchange resin. The drained water comes from a local scrubber and the waste ozone comes from an ozone generator of a process device.

In the apparatus and method for simultaneously processing waste ozone and drained water of the present invention, the gas/liquid mixing device substantially mixing the waste ozone and the drained water increases dissolution of ozone within the drained water. Moreover, the decomposition device is used to expose the drained water substantially dissolved with ozone for activating ozone, increasing the generating ration of hydroxyl ions within the drained water, dissolving organic carbon of the drained water and reducing total organic carbon of the drained water. Then, the absorption device absorbs ions of the drained water for recycling the drained water.

Because total organic carbon of the drained water is reduced by using waste ozone without processing the waste ozone, the manufacturing cost is reduced. In another aspect, the present invention efficiently removes waste ozone, while avoiding corrosion of the drained water pipeline, so the service life of the drained water pipeline is extended.

In order to make the aforementioned and other objects, features and advantages of the present invention understandable, a preferred embodiment accompanied with figures is described in detail hereinafter.

### BRIEF DESCRIPTION OF DRAWINGS

FIG. 1 is a schematic drawing showing a prior art apparatus for processing ozone.

FIG. 2 is a schematic drawing of a preferred apparatus for simultaneously processing waste ozone and drained water in accordance with the present invention.

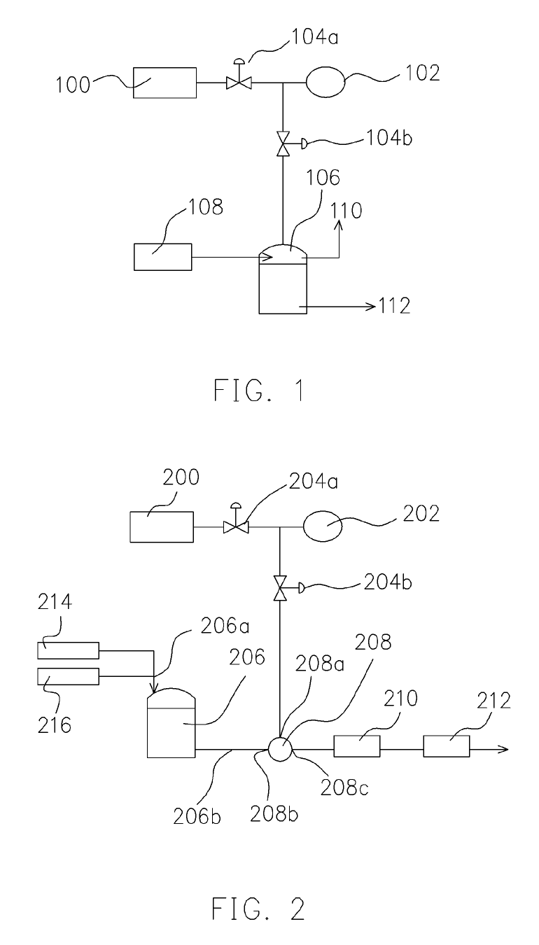

### DETAILED DESCRIPTION

FIG. 2 is a schematic drawing of a preferred apparatus for simultaneously processing waste ozone and drained water in accordance with the present invention.

Please referring to FIG. 2, the apparatus for simultaneously processing waste ozone and drained water includes a process device 200, an ozone generator 202, a drained water tank 206, a gas/liquid mixing device 208, a decomposition device 210 and an absorption device 212.

The process device 200 includes equipments using ozone during semiconductor fabrication, such as chemical vapor deposition equipments, plasma etch equipments, wafer cleaning equipments, etc.

The ozone generator 202 is coupled to the process device 200 for proving ozone thereto. A valve 204a is deposed between the process device 200 and the ozone generator 202, and a valve 204b is deposed between the gas/liquid mixing device 208 and the ozone generator 202. When the valve 204a is opened and 204b is closed, ozone coming from the ozone generator 202 flows into the process device 200. When the valve 204a is closed and 204b is opened, ozone coming from the ozone generator 202 flows into the gas/liquid mixing device 208.

The drained water tank 206 at least includes a drained water inlet 206a and a drained water outlet 206b for storing drained water coming from the process device. The drained water inlet is, for example, coupled to a process device 214 or a local scrubber 216 which generates the drained water.

The gas/liquid mixing device 208 includes a gas inlet 208a, a gas outlet 208b and an outlet 208c. The liquid inlet 208b is coupled to the drained water outlet 206b of the drained water tank 206 and the gas inlet 208a is coupled to the ozone generator 202 for substantially dissolving ozone into drained water. The gas/liquid mixing device 208 is, for example, a dissolving pump. Of course, the gas/liquid mixing device 208 is not limited to a dissolving pump. Any apparatus which can substantially mix gas and liquid can be applied thereto.

The decomposition device 210 is coupled to the gas/liquid mixing device 208 for decomposing organic carbon in the drained water. The decomposition device 210 is, for example, a UV lamp. The decomposition device 210 is used to expose the drained water substantially dissolved with ozone for activating ozone, increasing the generating ratio of hydroxyl ions within the drained water, dissolving organic carbon of the drained water and reducing total organic carbon of the drained water.

The absorption device 212 is coupled to the decomposition device 210 for absorbing ions within the drained water. The absorption device 212 is filled with, for example, active carbon or ion-exchange resin. When the drained water processed by the decomposition device 210 flows through the absorbing device 212, the active carbon or ion-exchange resin therein absorbs ions of within the drained water. Therefore, the drained water flowing through the absorption device 212 is recycled. Of course, the absorption device 212 is not limited to active carbon or ion-exchange resin; any material that can substantially provide the function of the same can be applied thereto.

The description above discloses the apparatus for simultaneously processing waste ozone and drained water; a method for simultaneously processing waste ozone and drained water is disclosed hereinafter in accordance with the apparatus described above.

Please referring to FIG. 2, when process device 200 is going to be operated, the valve 204a is opened and 204b is closed, and ozone flows into the process device 200. When ozone is not required for the process device 200, the valve 204a is closed and 204b is opened and ozone flows into the gas/liquid mixing device 208. The drained water from the process device 214 or the local scrubber 216 stored in the drained water tank 206 flows into the gas/liquid mixing device 208. The waste ozone can be from, for example, an ozone generator or process equipments.

The gas/liquid mixing device 208 then substantially mixes the waste ozone and the drained water from the drained water tank for enhancing dissolution of ozone within the drained water. Then, the drained water substantially dissolved with ozone flows into the decomposition device 210. Then the decomposition device 210 is used to exposes the drained water for increasing the generating ratio of hydroxyl ions within the drained water, substantially dissolving organic carbon of the drained water and reducing total organic carbon of the drained water.

Ions within the drained water processed by the decomposition device 210 are then absorbed by the absorption device 212. Therefore, the drained water flowing through the absorption device 210 is recycled.

According to the preferred embodiment described above, in the apparatus for simultaneously processing waste ozone and drained water, the gas/liquid mixing device 208, such as a dissolving pump, substantially mixes waste ozone and drained water for enhancing dissolution of ozone within the drained water. Moreover, the decomposition device 210, such as a UV lamp, substantially exposes the drained water substantially dissolved with ozone for increasing the generating ratio of hydroxyl ions within the drained water, substantially dissolving organic carbon of the drained water and reducing total organic carbon of the drained water.

Because total organic carbon of the drained water is reduced by using waste ozone without processing the waste ozone, the manufacturing cost is reduced. In another aspect, the present invention efficiently removes waste ozone, while avoiding corrosion of the drained water pipeline, so the service life of the drained water pipeline is extended.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. An apparatus for simultaneously processing waste ozone and drained water, comprising:
a process device;
an ozone generator coupled to the process device for providing ozone to the process device;
a drained water tank at least having a drained water inlet and a drained water outlet;
a gas/liquid mixing device having a gas inlet, a liquid outlet and an outlet, the liquid inlet coupled to the drained water outlet of the drained water tank, the gas inlet coupled to the ozone generator for substantially dissolving ozone into drained water;
a decomposition device coupled to the gas/liquid mixing device for decomposing organic carbon in the drained water; and
an absorption device coupled to the decomposition device for absorbing ions within the drained water.

2. The apparatus for simultaneously processing waste ozone and drained water of claim 1, wherein the gas/liquid mixing device comprises a dissolving pump.

3. The apparatus for simultaneously processing waste ozone and drained water of claim 1, wherein the decomposition device comprises a UV lamp.

4. The apparatus for simultaneously processing waste ozone and drained water of claim 1, wherein the absorption device comprises active carbon.

5. The apparatus for simultaneously processing waste ozone and drained water of claim 1, wherein the absorption device comprises ion-exchange resin.

6. The apparatus for simultaneously processing waste ozone and drained water of claim 1, wherein the drained water outlet of the drained water tank is coupled to a local scrubber.

7. A method for simultaneously processing waste ozone and drained water, comprising:
collecting waste ozone and drained water of a process device;
substantially dissolving the waste ozone into the drained water;
increasing a generating ratio of the hydroxyl ions of the drained water for reducing total organic carbon of the drained water; and
absorbing ions from the drained water.

8. The method for simultaneously processing waste ozone and drained water of claim 7, wherein the step of substantially dissolving the waste ozone into the drained water comprises using a dissolving pump for substantially dissolving the waste ozone into the drained water.

9. The method for simultaneously processing waste ozone and drained water of claim 7, wherein the step of increasing the generating ratio of hydroxyl ions of the drained water for reducing total organic carbon of the drained water comprises exposing the drained water by using a UV lamp to dissolve the organic carbon of the drained water.

10. The method for simultaneously processing waste ozone and drained water of claim 7, wherein the step of absorbing ions from the drained water comprises absorbing the ions from the drained water by using active carbon.

11. The method for simultaneously processing waste ozone and drained water of claim 7, wherein the step of absorbing ions from the drained water comprises absorbing the ions from the drained water by using ion-exchange resin.

12. The method for simultaneously processing waste ozone and drained water of claim 7, wherein the drained water comes from a local scrubber.

13. The method for simultaneously processing waste ozone and drained water of claim 7, wherein the waste ozone comes from an ozone generator of a process device.
